(19) United States
(12) Patent Application Publication
(10) Pub. No.: US 2007/0298821 A1
(43) Pub. Date: Dec. 27, 2007

(54) System for boolean network configuration of a wireless network

(75) Inventor: Stephen Francis Bush, Latham Park, NY (US)

Correspondence Address: TAROLLI, SUNDHEIM, COVELL & TUMMINO LLP, Suite 1700, 1300 East Ninth Street, Cleveland, OH, 44114, US

(73) Assignee: Lockheed Martin Corporation

(21) Appl. No.: 11/471,898

(22) Filed: Jun. 21, 2006

(51) Int. Cl. H04B 7/00; H04Q 7/20

(52) U.S. Cl. 455/507

(57) ABSTRACT

A system automatically and dynamically forms clusters from a plurality of boolean network nodes of a mobile wireless network. A primary node of the plurality of boolean network nodes detects adjacent nodes of the plurality of boolean network nodes. The primary node randomly selects a boolean state for the primary node. The primary node transmits the boolean state to the adjacent nodes. The primary node receives boolean states from the adjacent nodes. The primary node determines a next boolean state based on inputs from the adjacent nodes. The primary node records the next boolean state incrementally over time. The primary node determines whether the recorded next boolean states defines a cycle comprising all ones or all zeroes. The primary node is a clusterhead node if the recorded next boolean states comprise all ones or all zeroes.

### FIELD OF INVENTION

The present invention relates to a system for configuring a network, and more particularly, to a system for configuring a wireless network.

### BACKGROUND OF THE INVENTION

Conventional networks may be partitioned by clusters of nodes that are optimal in some fashion, e.g., minimum power, maximum throughput, etc. Conventional clustering approaches include a series of message exchanges among nodes to determine clusters and the election of a clusterhead. These message exchanges may create overhead in the network and reduce the network's ability to rapidly adapt clustering and/or partitioning.

### SUMMARY OF THE INVENTION

A system in accordance with the present invention automatically and dynamically forms clusters from a plurality of boolean network nodes of a mobile wireless network. A primary node of the plurality of boolean network nodes detects adjacent nodes of the plurality of boolean network nodes. The primary node randomly selects a boolean state for the primary node. The primary node transmits the boolean state to the adjacent nodes. The primary node receives boolean states from the adjacent nodes. The primary node determines a next boolean state based on inputs from the adjacent nodes, as shown in the example truth table of FIG. 3. The primary node records the next boolean state incrementally over time. The primary node determines whether the recorded next boolean states defines a cycle comprising all ones or all zeroes. The primary node is a clusterhead node if the recorded next boolean states comprise all ones or all zeroes.

A computer program product in accordance with the present invention automatically and dynamically forms clusters from a plurality of boolean network nodes of a mobile wireless network. The computer program product includes: a first instruction detecting adjacent nodes of the plurality of boolean network nodes; a second instruction for randomly selecting a boolean state; a third instruction for transmitting the boolean state to the adjacent nodes; a fourth instruction for receiving boolean states from the adjacent nodes; a fifth instruction for determining a next boolean state based on inputs from the adjacent nodes; a sixth instruction for recording the next boolean state incrementally over time; a seventh instruction for determining whether the recorded next boolean states define a cycle comprising all ones or all zeroes; and an eighth instruction for defining a clusterhead node if the recorded next boolean states comprise all ones or all zeroes.

Another system in accordance with the present invention automatically and dynamically forms clusters from a plurality of boolean network nodes of a mobile wireless network. A primary node of the plurality of boolean network nodes detects adjacent nodes of the plurality of boolean network nodes. The primary node randomly selects a boolean state for the primary node. The primary node transmits the boolean state to the adjacent nodes. The primary node receives boolean states from the adjacent nodes. The primary node determines a next boolean state based on inputs from the adjacent nodes and a truth table. The primary node records the next boolean state incrementally over time. The primary node determines whether the recorded next boolean states define a cycle comprising all ones or all zeroes. The primary node is a clusterhead node if the recorded next boolean states comprise all ones or all zeroes.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic representation of an example system in accordance with the present invention;

FIG. 2 is a schematic representation of an example computer program product in accordance with the present invention; and

FIG. 3 is an example truth table for use with the example system of FIG. 1.

### DESCRIPTION OF AN EXAMPLE EMBODIMENT

Communication networks may be more efficiently utilized (i.e., reducing power consumption, etc.) by forming groups of nodes and electing one node to act on the group's behalf. Partitioning a network into an optimal cluster may require communication overhead. A system in accordance with the present invention may provide a low-overhead means of enabling the network to partition itself.

Nodes within immediate communication range of one another may form a Boolean network. The nodes of the Boolean network may exchange short, low-energy pulses until an attractor is determined. An attractor is determined by a cycle of node on/off transitions such that “on” nodes are clusterheads and “off” nodes join nearest clusterheads as members of that cluster.

More complex topologies may exhibit more complex attractors yielding more clusterheads. The attractor cycle may also establish dynamically changing clusters. A Boolean Network configuration of the system may result in low energy, efficient partitioning of network nodes into clusters and the identification of cluster heads. The system results in an efficient clustering of nodes taking into account network traffic, node capability, and node density.

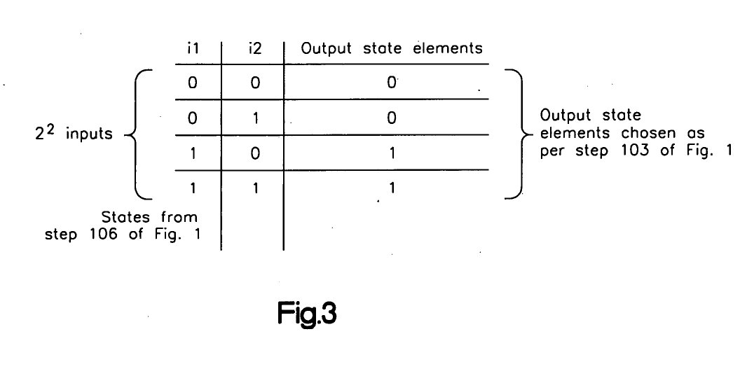

The system requires low overhead, or low energy, to establish a clustering Boolean function. The Boolean function may be used at each node to determine firing and may be adjusted in relation to a particular optimal parameter, such as traffic load. As the output entropy of the Boolean function increases (see FIG. 3), total system attractor complexity increases, yielding more clusters. The system thereby may enable rapid reconfiguration of network clustering.

The system may provide low overhead, as stated above. Only the nearest neighbor nodes need interact with each other for clustering. The system may provide enhanced security since it may be difficult to detect clustering behavior (i.e., an outside observer would have a difficult time anticipating a clustering result, etc.). The system may also provide simplicity in that a relatively simple code is required for each node to cluster and re-cluster.

Below is an example algorithm for an example system in accordance with the present invention.
1. Form a Boolean Network:
   a. Each node of an ad hoc wireless network is a Boolean network node;
   b. Wireless ad hoc nodes form Boolean network links when adjacent communication links form;
   c. The Boolean network begins operating with a randomly generated Boolean function at each node; the probability of one for each function may be specified;
2. Set value of p (probability of 1 in Boolean truth table) at each node to be 0.5*load (where load is a proportion of available capacity utilized);
3. Run Boolean Network until attractor forms (until a stable cycle is reached in the nodes' on/off state transitions);
4. Nodes in the “On” state are clusterheads and nodes in the “Off” state are members of clusters;
5. Non-clusterhead nodes join clusterhead nodes by choosing directly connected clusterhead node OR join clusterhead node with lowest utilization when multiple clusterhead nodes are available (utilization refers to traffic flowing through the clusterhead node).

The example system may provide self-configuration, difficulty for externally detecting a final result, larger loads yielding greater attractor complexity and more clusterheads, larger concentrations of nodes yielding more complex attractors and more clusterheads, and feasible partitioning. The system also results in the number of clusterheads growing with the complexity of attractors, which in turn grows with the number of nodes and links. Members may join clusterheads with which the members have large traffic flows. The system provides clusterheads in a center of mass of regions with high loads.

The system may greatly facilitate installation and maintenance of large-scale wireless ad hoc and sensor networks through self-configuring network services and resources. The Boolean Network of the system provides a framework for mathematically modeling self-configuration and self-organization for communication networks.

Conventionally, probes have been used to measure the amount of order and disorder within an operational network. Complexity estimation probes have been used to estimate Kolmogorov Complexity while l/f noise has been measured. The l/f noise-term may be the Laplace Transform of a power-law distribution. The Laplace Transform may be a means of searching for Per Bak's self-organized criticality (SOC). This behavior may be inherent to Random Boolean Networks.

A system in accordance with the present invention may harness this behavior to facilitate self-organization of communication networks. l/f noise may be generated by a system with inherent self-organization in the form of minimally stable states. The system may become stable precisely at the point when the minimally stable states have been broken down to a level where a noise signal (i.e., perturbation) ceases communication within the system. Clusters of minimally stable states may be scale-invariant and exhibit a power-law distribution. Thus, communication of a noise signal may be indicative of self-organization.

The term “minimally stable” may be “residing at the edge of chaos” within a Boolean Network framework. The system may passively seek unanticipated order and disorder within a network. The system may observe a rate of change of order over time, while also seeking a particular order indicative of self-organization.

Self-organization may be defined as the behavior exhibited by networks that become more ordered, without external influence. Self-organization may also be defined as an internal increase, without external influence, in the complexity of the minimum information required to predict the network's dynamics.

An important part of self-organization is “self”. This may be termed as a quantification of a “degree of self”. Degree of self may be scale-invariant. It may thus be impossible to decompose the “self” capability from an inherent operation of a network. Degree of self and emergence may be related; both may imply functionality that cannot be decomposed or separated without altering inherent operation of a network.

A quantification of self-configuration may relate a sense of “self-ness” (i.e., “self” or an external configuration algorithm that is packaged with the system, etc.) A truly self-configuring system subsumes its own “self-function” by its base functionality. A partial self-configuration may include some external control to configure the system. A non-self-configuring system includes configuration completely separate from the base functionality of the system.

Network layers may be the antithesis of degree of self and emergence. A truly cross-layer network may have network layer functionality subsumed by system functionality.

Based upon a proposed degree of self, wireless ad hoc networks may not be self-organizing because, for example, it may be possible to decompose routing from network functionality; routing may be a separately engineered function forced upon the network.

A proposed measure for degree of self may be based upon several paradigms. One is the degree of difficulty in separating the self-function from the base function; that is, the ability to identify components contributing to the self-function. Alternatively, structural distinctions, similar to immunological approaches may be used to distinguish base from self; signatures distinguishing base from self may be utilized. Also, behavioral distinctions, based upon impact on environment, may be utilized.

A preferred approach may be based upon information theoretic distinctions, the mutual information (M) between the base (b) and self-functions (s) may be indistinguishable as defined in equations (1) and (2), below:

M(b|s)=H(b) (1)

K(b|s)=K(b) (2)

where H is entropy and K is Kolmogorov Complexity.

Self-configuration may be defined as an inherent optimization and tuning of network parameters. Self-configuration typically is not defined as a network service because self-configuration is intended to be ubiquitous and inherent to the network. Tuning of network services may be defined as modifying network parameters in such a manner as to optimize a specific objective. Tuning may include the organization and placement of services within a network, such as gateways. Placement of network services may determine a node upon which a service may be initiated such that a specific objective is optimized.

A network service may be defined as any function not common to all nodes. This definition may seem broad; however, consider the optimal location of clusterheads in an ad hoc network. Every node may have the ability to become a clusterhead, but only a subset is actually elected.

Self-configuration may require interaction of elements of the system with one another in such a manner as to induce a desired global order. Self-organizing systems may exhibit positive and negative feedback, amplification of fluctuations, and intense interaction among components. Thus, frameworks that highlight and characterize an interaction of components with one another and allow for determination of global order to be quantified may be desirable.

Some possible frameworks may include a Boolean Network, Self-Organizing Maps (SOM), and Particle Swarm Optimization (PSO). SOMs may capture both local interaction of similar elements and a global collective result. A SOM may consist of a prototype vector in which the affinity of a given element to nearby vector elements is reinforced when data samples match the given element. This clustering behavior may be controlled by a generic distance metric and learning parameters.

PSO may be initialized with a population of random solutions and may search for optima by updating generations. Potential solutions, called particles, may travel through a problem space by following optimum particles. All particles may have fitness values, which are evaluated by a fitness function, and have velocities that direct the path of the particles. When a particle takes part of a population as its topological neighbors, a best value is a local best. Compared with Genetic Algorithms (GA), the information sharing mechanism in PSO is significantly different.

In GAs, chromosomes share information with each other. The whole GA population may move as a group towards an optimum. In PSO, only a best particle may transmit information to other particles. Thus, communication overhead may be localized.

In both SOM and PSO, a set of local interactions may determine a global outcome. A general framework in which to characterize an impact of these local interactions on a global result may be desirable. A Boolean Network framework may accomplish this.

Conventionally, Boolean Networks are known in the field of gene regulation, which is a highly apropos biological function; namely, the self-configuration of gene expression and the ultimate construction of proteins. Nodes in a Boolean Network may contain rules regarding state change. Rule input may come from adjacent node states. A result may be a series of state changes propagated through a network that eventually lead to a repeating cycle of changes known as attractors.

Conversely, a Boolean Network may yield a seeming random set of state changes or a chaotic sequence. A network may reside on the edge of chaos in order to be able to maintain its configuration given changing environmental stimuli. A Boolean Network may exhibit positive and negative feedback. A pure Boolean Network has no external input. State changes (positive and negative) feedback into the same network.

Amplification of fluctuations may occur in a Boolean Network. Small state changes may yield large changes in state trajectory (i.e., moving from order to chaos, etc.). As shown in equation (3) below, a critical number of connections may be characterized by a bias towards ones and zeroes. If a number of connections is less than a critical value, perturbations may die out quickly. If a number of connections exceeds a critical value, perturbations may propagate throughout an entire network (chaotic), Kc may be plotted as a function of p:

$${K}_{c} = \frac{1}{2 p ( 1 - p )} \qquad ( 3 )$$

Conventional NK Boolean Networks may consist of N nodes where each node has K inputs. A node may implement a Boolean function. The node may receive inputs and return a Boolean output. An additional parameter p may characterize a Boolean Network. p is the probability of an “1” output.

In a spatial positioning of nodes, the on/off states may form patterns over time. The network may appear chaotic. However, since there are only a finite number of possible states, there must be repeating states, either frozen or cyclic. A cyclic state pattern, from which there is no escape, are known as attractors.

There may be two desirable properties of a Boolean network for self-organization and self-tuning, homeostasis and graceful stability. Homeostasis means that nearby states generally flow to the same attractor. Graceful stability means that changing a truth table, or changing connections slightly, has only a minor effect on the attractors.

General characteristics of Boolean Network behavior are described as a function of K, N, and p. When K is one, there may tend to be short state cycles that are reached quickly. When K is equal to N and p is equal to 0.5, there may tend to be long state cycles and a small number of attractors, approximately N/e as well as little homeostasis.

Flipping one bit in a state cycle may lead to a different cycle, but may be chaotic and not exhibit graceful stability. Changing a truth table of one unit may cause massive changes in behavior. When K is four or five and p is 0.5, results may be similar to when K equals N—chaos. When K is 2 and p is 0.5 there is a well-behaved number of cycles, nearby states often go to the same attractor. When p is increased from 0.5 towards 1.0, it may have an effect similar to decreasing K.

It would be desirable to engineer attractors as an inherent characteristic of a wireless ad hoc network protocol. This may involve examining an arbitrary system and extracting its attractors. An analysis of the number of states that lead towards a desired state, described as a ratio of such states to total states, may be one measure of a network's robustness (brittleness).

Regarding the definition of degree of self, proposed earlier in equations (1) and (2), a Boolean Network may accomplish multiple functions simultaneously and inseparably. Specifically, consider b a base function (i.e., a basin and attractor that does useful work) and s the self-configuration capability (i.e., the ability of the system to either change or lead to a new attractor given a state change).

Each node may be cognizant only of its own inputs and output state—an individual nodes' views of local state changes. Globally, the network may be in an ordered or chaotic state. However, a node that knows only its own state will see an on/off pattern over time. This information may be caused by signals cascading throughout the network. An individual node's state may be frozen at one, zero, or consist of a cycle of on/off patterns as part of an attractor.

A Boolean Network is a framework for modeling communication protocols in a general and complex manner. Conventional network protocols are instances of trivial Boolean Networks. Both Boolean Networks and conventional communication protocols may accept input and generate output. Conventionally, all nodes are assumed to operate with the same set of programs, often precisely the same versions of the program, and generally communicate by a one-way transfer of information at time, either a pair-wise or multicast of information. A Boolean Network, however, may allow different programs (Boolean functions) on each node.

The result of viewing the Boolean network as a communication protocol with each wireless node as a Boolean Network node is that information is propagated, combined, and modified in complex ways. The resulting feedback cycles through the network provide a communication induced dynamic system that may yield self-organizing properties useful for improved communication.

Wireless networks may rely on integrating interactions between various layers of a network protocol stack. This is known as a cross-layer design. A Boolean Network may be a shim between conventional protocol-layers. A Boolean Network of network nodes may signal through its state changes and form attractors across the network, simultaneously configuring parameters across layers.

Transmission rate (physical layer) and congestion control (transport layer) may be correlated parameters that work together in a synergistic manner rather than as separate-layer mechanisms. There is no point in striving to achieve a high transmission rate (local behavior) when the network is congested (global characteristic).

Routing (network layer) is also currently separate from congestion control (transport layer). Routing, comprised of local link-by-link forwarding decisions, may influence the more global characteristic of network congestion.

Error correction (link layer) may generally be considered a local link layer function. However, error correction can be combined with other global functions and characteristics, such as routing and congestion control.

Transmission rate and load (physical layer) may be combined with traffic shaping (link or transport layers). Boolean Network attractors may serve as leaky bucket traffic shaper control. A higher node density and larger transmission radius may yield more chaos. This may generate longer attractor cycles and slower leakage, thus decreasing traffic rate.

Power control (physical layer) and transmit/receive scheduling (Media Access Control (MAC) layer) may also be linked via a Boolean Network framework. A higher density and larger transmission radius may imply a more chaotic (randomized) schedule.

Allocating buffer space (link/transport layer) on a wireless node may be combined with relative motion (MAC layer). Denser nodes and higher, more bursty traffic load may require larger queue sizes.

Nodes may partition themselves into clusters (MAC layer) based upon transmission range (physical layer) and motion entropy. Higher density and larger transmission radius with more traffic implies more chaos and larger attractor cycles. This may yield smaller cluster partitions.

A simple specific Boolean Network framework within a wireless ad hoc network may be implemented. The simple specific Boolean Network framework may be a simple mapping between communication node and Boolean Network node. More complex collections of Boolean Network nodes might represent a single communication node. Boolean Networks may be transported as active packets. Also, self-modifying Boolean Networks may drive interconnections by their current state.

Boolean Networks may form an archetype self-organizing model. A power-law change in node activity following a perturbation may demonstrate the l/f noise discussed earlier. Boolean Networks may perform general-purpose computation. However, Boolean Networks may be used for communication. Boolean Network interconnectivity may be reverse-engineered from observed state values.

An example algorithm may map a wireless ad hoc network topology to a Boolean Network instance. As wireless ad hoc node density increases, the number of potential connections increases. This increase in density may drive the Boolean Network into a more chaotic operating region. This is a desirable feature for many wireless ad hoc protocol applications, particularly those that require a higher degree of pseudo-random behavior as node density increases.

Such applications may include scheduling to avoid collision and traffic shaping. In addition, node clustering may require partitioning nodes such that a clusterhead maintains control over an optimal partition of nodes. Each of these problems may require some degree of self-organization and self-configuration, or robust collaborative formation of organized, but adaptable, behavior.

Each ad hoc node may be a single Boolean Network node. Ad hoc network interconnections may directly map to Boolean Network interconnections. A parameter p may control bias towards a one-output state for each Boolean Network node. The bias may be set to 0.5.

For coordinated movement, node trajectories may be generated as particles in vector field flows. However, random movement may be utilized. Six nodes may be randomly placed on a field. As nodes move within transmission range of one another, a graph showing potential communication paths is generated. For each movement sample, the largest connected component may be extracted for analysis.

For each time sample, a mapping from the wireless ad hoc network topology to a Boolean Network may occur such that each wireless transmission link may be a Boolean Network connection and each node may be a Boolean Network node. Node labels and connections may be equivalent, with the exception of self-inputs. Self-inputs may be included in the Boolean Network in order to increase the number of attractors. Without self-inputs, the number of attractors may not exceed one. Nodes may become disconnected during movement.

States may be represented as a decimal value of the binary sequence of node states, with node one in the least significant bit position, and this value is incremented by one. Thus, there is not state zero. State changes may start from state one (0,0,0,0,0)₂+1. The state transitions may indicate that an attractor has been reached, resulting in an endless repetition of states. It is these cycles that the system may leverage.

Node mobility within the wireless ad hoc network may induce potential interconnectivity. Every potentially interconnected set of nodes may be represented by a topological graph. The wireless network topology may induce a Boolean Network such that each wireless node is a boolean function (bf). The boolean function may be assigned random values with a bias towards the number of binary one outputs. The defined output sequence for each boolean function may have a corresponding complexity.

Complexity (i.e., Kolmogorov complexity, etc.) may seek the smallest program, or algorithm, that describes x. This definition necessarily implies that a bit string x requiring a larger smallest program to describe the bit-string is more complex.

In general, a wide range of programs, or algorithmic descriptions, may generate a bit-string. Often, it is the case that the size of a program, or with regard to the definition above, the algorithmic description, may be traded-off for speed. Thus, the above definition of complexity may be distinguished from space and time complexity. From the standpoint of bandwidth, small size, namely, the complexity, which must be approximately equal to, or smaller than, the static data is desirable. However, from the standpoint of processing speed, faster, but possibly larger code, maybe desired.

Now consider C_{f}(x|y)−min {l(p):f(p,y)−n(x)}. In this case, the complexity of x is conditioned upon y. This may mean that executing program p with input y generates n(x). Conditional complexity is significant because an active packet may contain both code and data, the proportion of which may vary. Consider p as the code in an active packet. y may be a conditional bit-string for determining conditional complexity as static data in the packet. x may be the final “piece” of information to be sent, represented as a bit-string. The function ƒ may be the network processor (NodeOS/EE) upon which the packet is executed.

With regard to active packets and information theory, passive data is simple Shannon compressed data, and active packets are a combination of data and program code whose efficiency may be estimated by means of Kolmogorov Complexity. An active network Kolmogorov Complexity estimator may currently be implemented as a quick and simple compression estimation method thereby returning an estimate of the compressed size of a string. Thus, complexity is based upon computing the entropy of the weight of ones in a string.

Specifically, it is defined in equation (4) below where x#1 is the number of one-bits and x#0 is the number of zero-bits in the string whose complexity is to be determined. Entropy is defined in equation (5) below. An expected complexity may be asymptotically related to entropy as shown in equation (6) below. No completely accurate Kolmogorov Complexity estimator has yet been developed; thus this estimator may overestimate complexity and longer bit-strings of the same complexity may yield higher inverse compression ratios.

Network graph bit-strings of wireless network interconnectivity and Boolean Network state graphs may-be formed such that each bit position represents a possible node connection for each of the

$$( {n}_{2} )$$

possible connections. A bit set to one may represent a connection and a bit set to zero may indicate no connection.

$$\begin{matrix}\hat{K} ( x ) \approx 1 ( x ) H ( \frac{x \#1}{X \#1 + x \#0} ) + {log}_{2} ( 1 ( x ) ) & ( 4 ) \\ H ( p ) = - p {log}_{2} p - ( 1.0 - p ) {log}_{2} ( 1.0 - p ) & ( 5 ) \\ H ( X ) = {\sum }_{1 ( x ) = n} P ( X = x ) K ( X ) & ( 6 )\end{matrix}$$

Individual Boolean functions and the interconnections among them (gbn) may induce state changes in the operating Boolean network (traj) that may lead to attractors (attr). A Boolean Network state transition graph may be generated to explicitly show the flow of the system through all possible state transitions (gstate).

A scale-free network may have a number of links that do not scale with the number of nodes in the network. In terms of routing, these links may yield scalable routing table sizes while providing full network connectivity. Equation (7) below shows the scale-free power-law distribution.

P(k)αk^{-y} (7)

The probability of an occurrence of a node degree as a function of degree magnitude may be plotted. Again, there is a high probability of small degree nodes and smaller probabilities of higher degree nodes.

A discrete Fourier Transform of a sample trajectory may be plotted alongside an l/f curve. The scale-free node degree distributions, as well as the l/f characteristic in the Fourier Transform, may be characteristic of Boolean Network samples from a wireless ad hoc network.

A large amount of data characterizing the Boolean Network operation embedded within the wireless ad hoc network may be gathered with many possible correlations and explanations. One technique to determine relationships and patterns among the data may be principle components analysis. Principle components analysis is related to Kolmogorov Complexity and compression because it determines dimensions within multidimensional data that most closely align with, and thus may be used to describe, the data. The dimensions with a least descriptive power may be dropped with minimal loss in description of the data. Principal components analysis may be used, for example, as the base for image compression algorithms.

The principle components may be determined by obtaining an Eigenvector and Eigenvalue of a covariance matrix. The Eigenvector may provide orthogonal dimensions that best align with the data and the Eigenvalue may indicate how well the dimensions describe the data.

A largest Eigenvalue may describe a dimension consisting primarily of a basin size and a number of attributes. A next largest may be a number of attractors and a Boolean Network state graph diameter. A third largest Eigenvalue may indicate a relation between a state graph diameter and a wireless ad hoc network diameter. Below is an example table of definitions of ad hoc wireless network Boolean Network variables.

| Name | Value |
|---|---|
| N | Number of Nodes |
| K | Expected Number of Connections |
| P | Probability of One Output |
| Satt | Expected Attractor Size |
| Natt | Number of Attractors |
| Sbasin | Expected Basin Size |
| Hdist | Maximum Hamming Distance |
| Topkc | Topological Complexity |
| Bfkc | Boolean Function Complexity |
| Ktraj | Trajectory Complexity |
| Ktc | Attractor Complexity |
| Gd | Wireless Ad Hoc Network Diameter |
| Gsd | Boolean Network State Graph Diameter |
| Cc | Wireless Ad Hoc Network Cluster Coefficient |
| Bp | Basin to Attract Proportion |
| Ncycles | Wireless Ad Hoc Network Cycles |
| Elcyc | Expected Cycle Length |

Attractors, as well as self-tuning parameters, may form self-forming stable patterns in a dynamic network system. A mechanism for creating a self-tuning parameter using the Boolean Network may map the parameter onto a trajectory, particularly an attractor. The same self-organizing dynamics may be leveraged within a Boolean Network to enable self-tuning of a wireless ad hoc network parameter.

If A is a matrix of dimension nv comprised of n nodes and v trajectory values, x is a weighting for each node, and b is a set of desired parameter values, then the solution to Ax=b yields weights for each node such that, when pulled into an attractor, the desired parameter value results. A more complex trajectory may force a solution that more evenly distributes the parameter over available nodes in such a manner as to adjust in a less brittle manner to specific conditions. It is this dynamic feedback, among the nodes, that may maintain a tuned parameter.

A simple linear mapping of trajectory to parameter values may be formed using a Mathematics function, where tr is matrix A, knob is b and s is the weighting for each node. For example, seven nodes may maintain a parameter setting arbitrarily selected to be 500. This solution may be specific to a particular Boolean Network and attractor. Next, the performance of this particular mapping may be examined.

In(247)=e=LinearSolve[tr, knob]

Out(247)={250, 250, 0, 250, 0, 0, 0}

The above matrix equations may represent a cross-layer parameter mapped to a Boolean Network trajectory. Although a constant parameter was chosen in this example, a variable parameter, whose value varies with the trajectory, may also be chosen. This particular weighting may yield a variance in the parameter value. The variance in the parameter value may depend upon the starting state's distance from the attractor as well as the specific Boolean Networks that formed during node motion.

The system provides that all trajectories eventually lead to attractors and degree of self leading to multiple goals occurring simultaneously. Self-tuning may occur because changes in the trajectory, caused by any environmental conditions, leads back to an attractor. The system further provides self-organized criticality and identification of attractors from trajectories through estimates of their state sequence complexity estimated via inverse compression ratio.

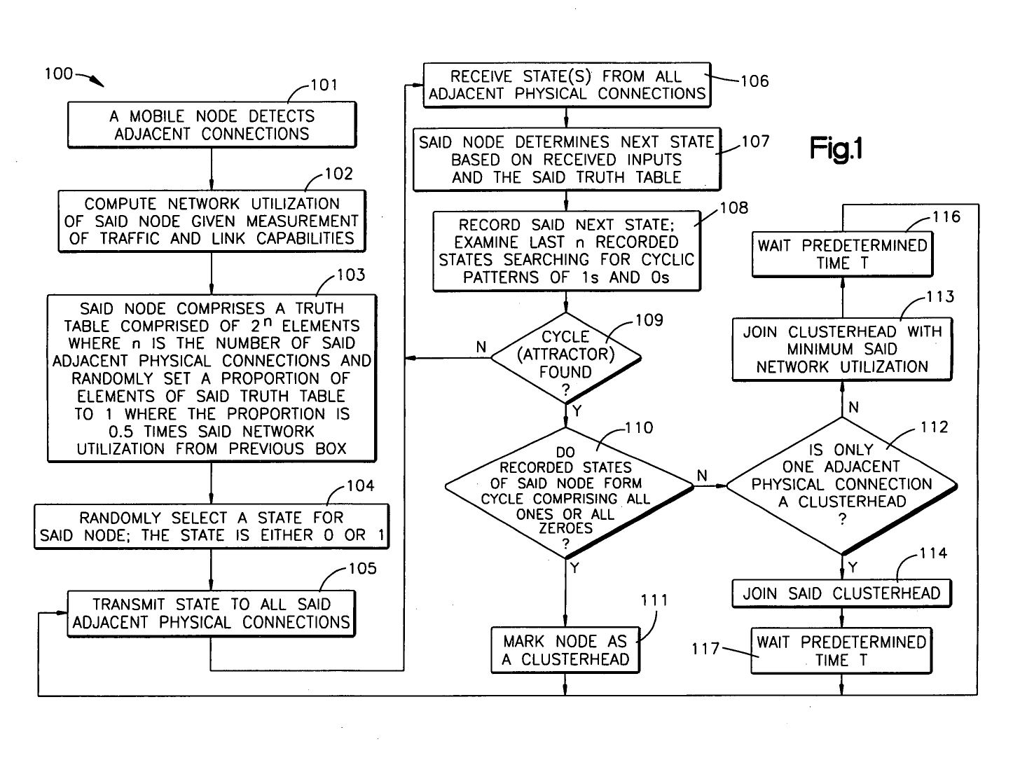

As shown in FIG. 1, an example system 100 in accordance with the present invention automatically and dynamically forms clusters of boolean network nodes of a wireless network and clusterheads for each cluster. Each node of the network may execute the example system 100. The system 100 begins at step 101 by a node detecting adjacent physical connections, such as neighboring nodes. From step 101, the example system 100 proceeds to step 102.

In step 102, a node of the example system 100 computes its own network utilization by using a measurement of traffic and link capabilities. From step 102, the example system 100 proceeds to step 103. In step 103, a node of the example system 100 provides a truth table with 2̂n elements where n is the number of adjacent physical connections. The node may randomly set a proportion of elements of the truth table to 1 where the proportion is 0.5 times the network utilization from step 102. From step 103, the example system 100 proceeds to step 104.

In step 104, a node of the example system 100 randomly selects a state for the node that is either 0 or 1. From step 104, the example system 100 proceeds to step 105. In step 105, a node of the example system 100 transmits the randomly selected state to the adjacent physical connections. From step 105, the example system 100 proceeds to step 106.

In step 106, a node of the example system 100 receives states from the adjacent physical connections (i.e., nodes performing the same example system 100 as the node in this example). From step 106, the example system 100 proceeds to step 107. In step 107, a node of the example system 100 determines a next state based on the received states from step 106 and its truth table. From step 107, the example system 100 proceeds to step 108.

In step 108, a node of the example system 100 records the next state, examines the last n recorded states, and searches for a cyclic pattern of 1's and 0's. From step 108, the example system 100 proceeds to step 109. In step 109, a node of the example system 100 determines whether a cycle has been found. If no cycle has been found, the node of the example system 100 proceeds back top step 106. If a cycle has been found, the node of the example system 100 proceeds to step 110.

In step 110, the node of the system 100 determines whether the states of the cycle are all 1's or all 0's. If the end states of the cycle are 1's, the node of the example system 100 proceeds to step 111. In step 111, the node of the example system 100 marks itself as a clusterhead. From step 111, the node of the example system 100 proceeds back to step 105.

If the end states in the cycle of step 110 are not 1's, the node of the example system 100 proceeds to step 112. In step 112, the node of the example system 100 determines whether only one of its physical connections is a clusterhead. If only one of its physical connections is a clusterhead, the node of the example system 100 proceeds to step 114. If none or more than one of its physical connections is a clusterhead, the node of the example system 100 proceeds to step 113.

In step 113, the node of the example system 100 joins a clusterhead having a minimum network utilization. Following step 113, the node of the example system 100 proceeds to step 116. In step 116, the node of the example system 100 pauses a predetermined time t. Following step 116, the node of the example system 100 proceeds back to step 105.

In step 114, the node of the example system 100 joins the single connected clusterhead. Following step 114, the node of the example system 100 proceeds to step 117. In step 117, the node of the example system 100 pauses a predetermined time t. Following step 117, the node of the example system 100 proceeds back to step 105.

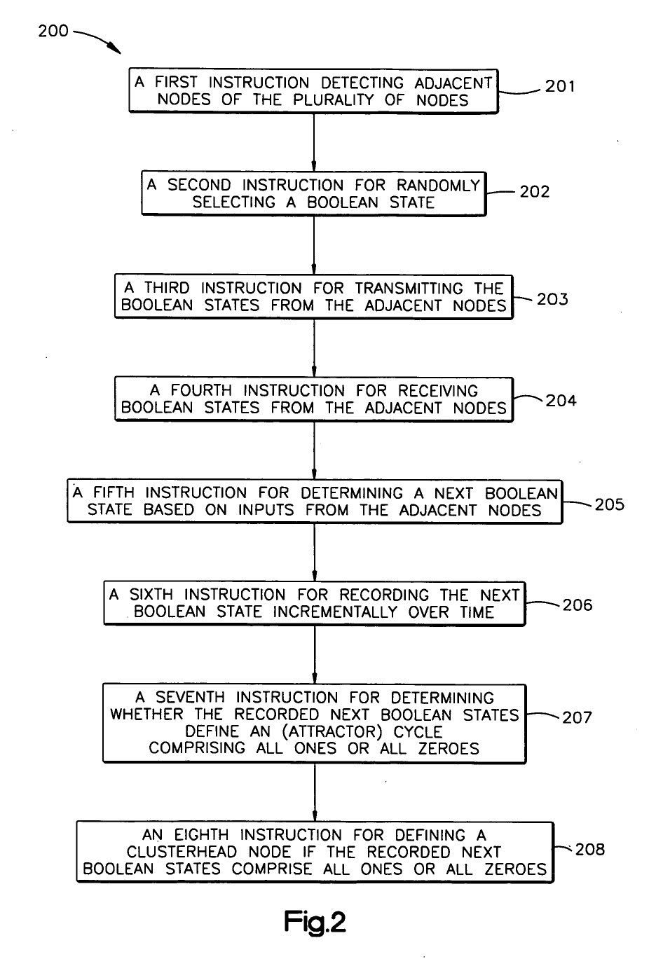

As shown in FIG. 2, an example computer program product 200 automatically and dynamically forms clusters from a plurality of boolean network nodes of a mobile wireless network. The computer program product 200 includes: a first instruction 201 detecting adjacent nodes of the plurality of boolean network nodes; a second instruction 202 for randomly selecting a boolean state; a third instruction 203 for transmitting the boolean state to the adjacent nodes; a fourth instruction 204 for receiving boolean states from the adjacent nodes; a fifth instruction 205 for determining a next boolean state based on inputs from the adjacent nodes; a sixth instruction 206 for recording the next boolean state incrementally over time; a seventh instruction 207 for determining whether the recorded next boolean states define a cycle comprising all ones or all zeroes; and an eighth instruction 208 for defining a clusterhead node if the recorded next boolean states comprise all ones or all zeroes.

In order to provide a context for the various aspects of the present invention, the following discussion is intended to provide a brief, general description of a suitable computing environment in which the various aspects of the present invention may be implemented. While the invention has been described above in the general context of computer-executable instructions of a computer program that runs on a computer, those skilled in the art will recognize that the invention also may be implemented in combination with other program modules.

Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications argument model. However, some, if not all aspects of the invention can be practiced on stand-alone computers. In a distributed computing environment, program modules may be located in both local and remote memory storage devices.

An exemplary system for implementing the various aspects of the invention includes a conventional server computer, including a processing unit, a system memory, and a system bus that couples various system components including the system memory to the processing unit. The processing unit may be any of various commercially available processors. Dual microprocessors and other multi-processor architectures also can be used as the processing unit. The system bus may be any of several types of bus structure including a memory bus or memory controller, a peripheral bus, and a local bus using any of a variety of conventional bus architectures. The system memory includes read only memory (ROM) and random access memory (RAM). A basic input/output system (BIOS), containing the basic routines that help to transfer information between elements within the server computer, such as during start-up, is stored in ROM.

The server computer further includes a hard disk drive, a magnetic disk drive, e.g., to read from or write to a removable disk, and an optical disk drive, e.g., for reading a CD-ROM disk or to read from or write to other optical media. The hard disk drive, magnetic disk drive, and optical disk drive are connected to the system bus by a hard disk drive interface, a magnetic disk drive interface, and an optical drive interface, respectively. The drives and their associated computer-readable media provide nonvolatile storage of data, data structures, computer-executable instructions, etc., for the server computer. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM, including an operating system, one or more application programs, other program modules, and program data. A user may enter commands and information into the server computer through a keyboard and a pointing device, such as a mouse. Other input devices (not shown) may include a microphone, a joystick, a game pad, a satellite dish, a scanner, or the like. These and other input devices are often connected to the processing unit through a serial port interface that is coupled to the system bus, but may be connected by other interfaces, such as a parallel port, a game port or a universal serial bus (USB). A monitor or other type of display device is also connected to the system bus via an interface, such as a video adapter. In addition to the monitor, computers typically include other peripheral output devices (not shown), such as speaker and printers.

The server computer may operate in a networked environment using logical connections to one or more remote computers, such as a remote client computer. The remote computer may be a workstation, a server computer, a router, a peer device or other common network node, and typically includes many or all of the elements described relative to the server computer. The logical connections include a local area network (LAN) and a wide area network (WAN). Such networking environments are commonplace in offices, enterprise-wide computer networks, intranets and the internet.

When used in a LAN networking environment, the server computer is connected to the local network through a network interface or adapter. When used in a WAN networking environment, the server computer typically includes a modem, or is connected to a communications server on the LAN, or has other means for establishing communications over the wide area network, such as the internet. The modem, which may be internal or external, is connected to the system bus via the serial port interface. In a networked environment, program modules depicted relative to the server computer, or portions thereof, may be stored in the remote memory storage device. It will be appreciated that the network connections shown are exemplary and other means of establishing a communications link between the computers may be used.

In accordance with the practices of persons skilled in the art of computer programming, the present invention has been described with reference to acts and symbolic representations of operations that are performed by a computer, such as the server computer, unless otherwise indicated. Such acts and operations are sometimes referred to as being computer-executed. It will be appreciated that the acts and symbolically represented operations include the manipulation by the processing unit of electrical signals representing data bits which causes a resulting transformation or reduction of the electrical signal representation, and the maintenance of data bits at memory locations in the memory system (including the system memory, hard drive, floppy disks, and CD-ROM) to thereby reconfigure or otherwise alter the computer system's operation, as well as other processing of signals. The memory locations where such data bits are maintained are physical locations that have particular electrical, magnetic, or optical properties corresponding to the data bits.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. A system for automatically and dynamically forming clusters from a plurality of boolean network nodes of a mobile wireless network, said system comprising:
a primary node of the plurality of boolean network nodes detecting adjacent nodes of the plurality of boolean network nodes,
said primary node randomly selecting a boolean state for said primary node, said primary node transmitting the boolean state to the adjacent nodes, said primary node receiving boolean states from the adjacent nodes,
said primary node determining a next boolean state based on inputs from the adjacent nodes, said primary node recording the next boolean state incrementally over time,
said primary node determining whether the recorded next boolean states define a cycle comprising all ones or all zeroes, said primary node being a clusterhead node if the recorded next boolean states comprise all ones or all zeroes.

2. The system as set forth in claim 1 wherein said primary node further includes a truth table including [2̂(the number of the adjacent nodes)] elements.

3. The system as set forth in claim 1 wherein said primary node computes a network utilization for said primary node utilizing traffic and link capabilities of said primary node.

4. The system as set forth in claim 1 wherein said primary node determines that there is only one adjacent clusterhead node.

5. The system as set forth in claim 4 wherein said primary node joins the clusterhead node.

6. The system as set forth in claim 1 wherein said primary node determines a next state based on the received inputs and a truth table.

7. The system as set forth in claim 1 wherein said primary node joins a clusterhead with a minimum network utilization.

8. The system as set forth in claim 1 wherein said primary node joins a clusterhead, waits a predetermined time interval, and transmits a Boolean state to the adjacent nodes.

9. The system as set forth in claim 1 wherein said primary node randomly sets a proportion of elements of a truth table to 1.

10. The system as set forth in claim 9 wherein the proportion of elements is defined by one-half of a network utilization of said primary node.

11. A computer program product for automatically and dynamically forming clusters from a plurality of boolean network nodes of a mobile wireless network, said computer program product comprising:
a first instruction detecting adjacent nodes of the plurality of boolean network nodes;
a second instruction for randomly selecting a boolean state;
a third instruction for transmitting the boolean state to the adjacent nodes;
a fourth instruction for receiving boolean states from the adjacent nodes;
a fifth instruction for determining a next boolean state based on inputs from the adjacent nodes;
a sixth instruction for recording the next boolean state incrementally over time;
a seventh instruction for determining whether the recorded next boolean states define a cycle comprising all ones or all zeroes; and
an eighth instruction for defining a clusterhead node if the recorded next boolean states comprise all ones or all zeroes.

12. The computer program product as set forth in claim 11 further including a ninth instruction for defining a truth table with [2̂(the number of the adjacent nodes)] elements.

13. The computer program product as set forth in claim 11 further including a ninth instruction for computing a network utilization utilizing traffic and link capabilities.

14. The computer program product as set forth in claim 11 further including a ninth instruction for determining an adjacent clusterhead node.

15. The computer program product as set forth in claim 14 further including a tenth instruction for joining the adjacent clusterhead node.

16. A system for automatically and dynamically forming clusters from a plurality of boolean network nodes of a mobile wireless network, said system comprising:
a primary node of the plurality of boolean network nodes detecting adjacent nodes of the plurality of boolean network nodes,
said primary node randomly selecting a boolean state for said primary node, said primary node transmitting the boolean state to the adjacent nodes, said primary node receiving boolean states from the adjacent nodes,
said primary node determining a next boolean state based on inputs from the adjacent nodes and a truth table, said primary node recording the next boolean state incrementally over time,
said primary node determining whether the recorded next boolean states define a cycle comprising all ones or all zeroes, said primary node being a clusterhead node if the recorded next boolean states comprise all ones or all zeroes.

17. The system as set forth in claim 16 wherein said primary node joins a clusterhead with a minimum network utilization.

18. The system as set forth in claim 16 wherein said primary node joins a clusterhead, waits a predetermined time interval, and transmits a boolean state to the adjacent nodes.

19. The system as set forth in claim 16 wherein said primary node randomly sets a proportion of elements of a truth table to 1.

20. The system as set forth in claim 19 wherein the proportion of elements is defined by one-half of a network utilization of said primary node.
